(19) United States
(12) Patent Application Publication
(10) Pub. No.: US 2014/0324745 A1
(43) Pub. Date: Oct. 30, 2014

(54) METHOD, AN APPARATUS AND A COMPUTER SOFTWARE FOR CONTEXT RECOGNITION

(71) Applicants: Jussi Leppänen, Tampere (FI); Antti Eronen, Tampere (FI); Jussi Collin, Viiala (FI)

(72) Inventors: Jussi Leppänen, Tampere (FI); Antti Eronen, Tampere (FI); Jussi Collin, Viiala (FI)

(73) Assignee: NOKIA CORPORATION, Espoo (FI)

(21) Appl. No.: 14/365,937

(22) PCT Filed: Dec. 21, 2011
(86) PCT No.: PCT/FI2011/051145

§ 371 Date: Jun. 30, 2014

(51) Int. Cl. G06N 99/00

(52) U.S. Cl. CPC G06N 99/005
USPC 706/12

(57) ABSTRACT

Various embodiments relate to a context recognition. Classification of a context is performed by using features received from at least one sensor of a client device, and model parameters being defined by a training data to output a result and a likelihood of the context. The result is shown to the user, who provides feedback regarding the result. The features, result, likelihood, and the feedback are stored, whereby the model parameters are adapted using the features, result, likelihood and the feedback to obtain adapted model parameters. The result, likelihood and the feedback can also be used for performing confidence estimation to obtain a confidence value. The confidence value can then be used for performing an action, e.g. adding a new sensor, adding a new feature, changing a device profile, launching an application.

### TECHNICAL FIELD

Various embodiments relate to context recognition, and in particular to pattern classification.

### BACKGROUND

Context-aware computing describes a technology that adapts different functions in computerized devices according to the context. For example, usage situations and environment of a mobile device may define how the appearance and functionality of a certain application should be adapted. Mobile devices can easily utilize location, time and applications as context data sources, but mobile devices may also contain various sensors for providing context information, for example relating to user activity based on movements and dynamic gestures being defined by e.g. accelerometer signals.

Classification is an example of a method for context recognition. In classification an unknown object is assigned to a category according to its feature vector. A criterion for classifying objects to a certain classes is formed by presenting examples of objects with known classes to a classifier.

In many practical applications, a Bayesian classifier is used. The classifier represents classes by class distributions that describe the distribution of features associated with each class. These class distributions are often trained using features calculated from a large set of data collected from a large set of test subjects. The distributions obtained this way might work on average, but might not work at all for some people due to individual differences.

Classifiers taking into account individual differences of users can be developed by collecting data from a user together with labels of what context the data belongs to and then adapting the distributions to fit that data. In speech recognition, maximum a priori (MAP) and maximum likelihood linear regression (MLLR) are used. These methods require—in addition to the adaptation data—labels of what class the data belongs to.

Another method being based on feedback determines whether a feedback signal received from a user is positive or negative and updating a mean vector for a class accordingly. When the feedback is positive, the class mean vector is moved towards the adaptation data and when the feedback is negative, the class mean vector is moved away from the adaptation data. Such a system does not modify the class covariance matrices.

Moreover, for real-life applications that utilize any classification technique, it would be beneficial to have some sort of measure of confidence that the recognized class is also the correct one in addition to being the most likely one. Also, in real-life applications, the classifier is bound to make mistakes and noticing when these mistakes happen would be beneficial as well.

There is, therefore, a need for a solution that requires minimal feedback from a user for adapting distributions of a classifier and enabling the calculation a confidence value for a classification result.

### SUMMARY

Now there has been provided an improved methods and technical equipment implementing the method, by which the above problems are alleviated. Various aspects of the invention include a method, an apparatus, a server, a client and a computer readable medium comprising a computer program stored therein, which are characterized by what is stated in the independent claims. Various embodiments of the invention are disclosed in the dependent claims.

According to a first aspect, a method comprises performing classification of a context using features received from at least one sensor and model parameters being defined by a training data to output a result and a likelihood of the context; showing the result; obtaining feedback from the user regarding the result; storing the features, result, likelihood, and the feedback; and performing adaptation of the model parameters using the features, result, likelihood and the feedback to obtain adapted model parameters.

According to an embodiment, the classifier is a Bayesian classifier.

According to an embodiment, the adaptation comprises minimizing a function ƒ.

According to an embodiment, the function ƒ depends on the likelihood values.

According to an embodiment, the evaluation of the function ƒ comprises evaluating the likelihood values corresponding to yes and no answers against a threshold.

According to an embodiment, the function ƒ is in the form of

$$f = \frac{\vert A \vert}{N ( yes )} + \frac{\vert B \vert}{N ( no )} ,$$

where A={Lⱼ(yes)|Lⱼ(yes)>χ₉₅} and
B={L₁ (no)|Lⱼ (no)<χ₉₅} and where
|A| denotes the number of items in the set A;
j is an index of the current class;
Lⱼ(no) is the set of likelihood values corresponding to observations with “no”-tag;
N(no) is the total number of “no” answers;
Lⱼ(yes) is the set of likelihood values corresponding to observations with “yes”-tag;
N(yes) is the total number of “yes” answers;
likelihood values Lⱼ are defined as: Lⱼ=(z−μⱼ)^{T}sⱼΣⱼ⁻¹(z−μⱼ)
and adapted class parameters are obtained from

$${arg min}_{{s}_{j} ∈ {R}^{+} , {μ}_{j} ∈ {R}^{N}} f$$

According to an embodiment, the method comprises using unconstrained non-linear optimization methods for the optimization.

According to an embodiment, the method comprises communicating the features, result, likelihood and the feedback to another device.

According to an embodiment, the method comprises receiving adapted model parameters from the other device.

According to an embodiment, the method comprises stopping the adaptation when the function ƒ reaches the minimum.

According to an embodiment, the method comprises performing confidence estimation to obtain a confidence value using the result, likelihood and the feedback.

According to an embodiment, the method comprises stopping the adaptation if the confidence value substantially matches the user feedback.

According to an embodiment, the method comprises showing the result to a user.

According to a second aspect, a method for a confidence measurement at a client apparatus comprises performing a classification of a context using features received from at least one sensor and model parameters being defined by a training data to output a result and a likelihood; showing the result; obtaining feedback from the user regarding the result; storing the result, likelihood and the feedback; performing confidence estimation to obtain a confidence value using the result, likelihood and the feedback; and performing an action based on the confidence value.

According to an embodiment, the action is one of the following: adding a new sensor, adding a new feature, changing a device profile, launching an application.

According to an embodiment, the confidence estimation comprises estimating the probability of the user answering yes.

According to an embodiment, the confidence estimation comprises estimating at least one probability density function using the likelihood and the feedback.

According to an embodiment, the probability density function estimation is carried out by using a kernel estimate.

According to an embodiment, the classifier is a Bayesian classifier.

According to an embodiment, the method further comprises obtaining a location data.

According to an embodiment, the action comprises communicating the location data, the result and the confidence value to another device.

According to an embodiment, the method further comprises receiving a request or a service from the other device in response to the location data, the result and the confidence.

According to an embodiment, the method further comprises showing the result to the user.

According to a third aspect, a method for confidence measurement at a server comprises receiving a location data and a first confidence value; updating a database with the location data and a first confidence value; receiving a second location data; obtaining a second confidence value from the database corresponding to the second location data; performing an action based on the second confidence value, where the action is one of the following: communicating the confidence value to another device, requesting another device to perform context classification, requesting another device to collect more user feedback, providing a service.

According to an embodiment, the service is a recommendation or an advertisement.

According to a fourth aspect, an apparatus comprises a processor, memory including computer program code, the memory and the computer program code configured to, with the processor, cause the apparatus to perform at least the following: performing classification of a context using features received from at least one sensor and model parameters being defined by a training data to output a result and a likelihood of the context; showing the result; obtaining feedback from the user regarding the result; storing the features, result, likelihood, and the feedback; and performing adaptation of the model parameters using the features, result, likelihood and the feedback to obtain adapted model parameters.

According to an embodiment, the classifier is a Bayesian classifier.

According to an embodiment, the apparatus further comprises computer program code configured to, with the processor, cause the apparatus to perform at least the following: minimizing a function ƒ for the adaptation.

According to an embodiment, the function ƒ depends on the likelihood values.

According to an embodiment, the apparatus further comprises computer program code configured to, with the processor, cause the apparatus to perform at least the following: evaluating the likelihood values corresponding to yes and no answers against a threshold for the evaluation of the function ƒ.

According to an embodiment, the function ƒ is in the form of

$$f = \frac{\vert A \vert}{N ( yes )} + \frac{\vert B \vert}{N ( no )} ,$$

where A={Lⱼ(yes)|Lⱼ(yes)>χ₉₅} and
B={Lⱼ(no)|Lⱼ(no)<χ₉₅} and where
|A| denotes the number of items in the set A;
j is an index of the current class;
Lⱼ(no) is the set of likelihood values corresponding to observations with “no”-tag;
N(no) is the total number of “no” answers;
Lⱼ(yes) is the set of likelihood values corresponding to observations with “yes”-tag;
N(yes) is the total number of “yes” answers;
the likelihood values are defined as: Lⱼ=(z−μⱼ)^{T}sⱼΣⱼ⁻¹(z−μⱼ)
and adapted class parameters are obtained from

$${arg min}_{{s}_{j} ∈ {R}^{+} , {μ}_{j} ∈ {R}^{N}} f$$

According to an embodiment, the apparatus further comprises computer program code configured to, with the processor, cause the apparatus to perform at least the following: using unconstrained non-linear optimization methods for the optimization.

According to an embodiment, the apparatus further comprises computer program code configured to, with the processor, cause the apparatus to perform at least the following: communicating the features, result, likelihood and the feedback to another device.

According to an embodiment, the apparatus further comprises computer program code configured to, with the processor, cause the apparatus to perform at least the following: receiving adapted model parameters from the other device.

According to an embodiment, the apparatus further comprises computer program code configured to, with the processor, cause the apparatus to perform at least the following: stopping the adaptation when the function ƒ reaches the minimum.

According to an embodiment, the apparatus further comprises computer program code configured to, with the processor, cause the apparatus to perform at least the following: performing confidence estimation to obtain a confidence value using the result, likelihood and the feedback.

According to an embodiment, the apparatus further comprises computer program code configured to, with the processor, cause the apparatus to perform at least the following: stopping the adaptation if the confidence value substantially matches the user feedback.

According to an embodiment, the apparatus further comprises computer program code configured to, with the processor, cause the apparatus to perform at least the following: showing the result to the user.

According to a fifth aspect, an apparatus comprises a processor, memory including computer program code, the memory and the computer program code configured to, with the processor, cause the apparatus to perform at least the following: performing a classification of a context using features received from at least one sensor and model parameters being defined by a training data to output a result and a likelihood; showing the result; obtaining feedback from the user regarding the result; storing the result, likelihood and the feedback; performing confidence estimation to obtain a confidence value using the result, likelihood and the feedback; and performing an action based on the confidence value.

According to an embodiment, the action is one of the following: adding a new sensor, adding a new feature, changing a device profile, launching an application.

According to an embodiment, the confidence estimation comprises estimating the probability of the user answering yes.

According to an embodiment, the confidence estimation comprises estimating at least one probability density function using the likelihood and the feedback.

According to an embodiment, the apparatus further comprises computer program code configured to, with the processor, cause the apparatus to perform at least the following: carrying out the probability density function estimation by using a kernel estimate.

According to an embodiment, the classifier is a Bayesian classifier.

According to an embodiment, the apparatus further comprises computer program code configured to, with the processor, cause the apparatus to perform at least the following: obtaining a location data.

According to an embodiment, the apparatus further comprises computer program code configured to, with the processor, cause the apparatus to perform at least the following: communicating the location data, the result and the confidence value to another device.

According to an embodiment, the apparatus further comprises computer program code configured to, with the processor, cause the apparatus to perform at least the following: receiving a request or a service from the other device in response to the location data, the result and the confidence.

According to an embodiment, the apparatus further comprises computer program code configured to, with the processor, cause the apparatus to perform at least the following: showing the result to the user.

According to a sixth aspect, an apparatus comprises a processor, memory including computer program code, the memory and the computer program code configured to, with the processor, cause the apparatus to perform at least the following: receiving a location data and a first confidence value; updating a database with the location data and a first confidence value; receiving a second location data; obtaining a second confidence value from the database corresponding to the second location data; performing an action based on the second confidence value, where the action is one of the following: communicating the confidence value to another device, requesting another device to perform context classification, requesting another device to collect more user feedback, providing a service.

According to an embodiment, the service is a recommendation or an advertisement.

According to a seventh aspect, a computer program embodied on a non-transitory computer readable medium, the computer program comprises instructions causing, when executed on at least one processor, at least one apparatus to: perform classification of a context using features received from at least one sensor and model parameters being defined by a training data to output a result and a likelihood of the context; show the result; obtain feedback from the user regarding the result; store the features, result, likelihood, and the feedback; and perform adaptation of the model parameters using the features, result, likelihood and the feedback to obtain adapted model parameters.

According to an eighth aspect, a computer program comprises instructions causing, when executed on at least one processor, at least one apparatus to: perform classification of a context using features received from at least one sensor and model parameters being defined by a training data to output a result and a likelihood of the context; show the result; obtain feedback from the user regarding the result; store the features, result, likelihood, and the feedback; and perform adaptation of the model parameters using the features, result, likelihood and the feedback to obtain adapted model parameters.

According to a ninth aspect, a computer program embodied on a non-transitory computer readable medium, the computer program comprises instructions causing, when executed on at least one processor, at least one apparatus to: perform a classification of a context using features received from at least one sensor and model parameters being defined by a training data to output a result and a likelihood; show the result; obtain feedback from the user regarding the result; store the result, likelihood and the feedback; perform confidence estimation to obtain a confidence value using the result, likelihood and the feedback; and perform an action based on the confidence value.

According to a tenth aspect, a computer program comprises instructions causing, when executed on at least one processor, at least one apparatus to: perform a classification of a context using features received from at least one sensor and model parameters being defined by a training data to output a result and a likelihood; show the result; obtain feedback from the user regarding the result; store the result, likelihood and the feedback; perform confidence estimation to obtain a confidence value using the result, likelihood and the feedback; and perform an action based on the confidence value.

According to an eleventh aspect, a computer program embodied on a non-transitory computer readable medium, the computer program comprises instructions causing, when executed on at least one processor, at least one apparatus to: receive a location data and a first confidence value; update a database with the location data and a first confidence value; receive a second location data; obtain a second confidence value from the database corresponding to the second location data; perform an action based on the second confidence value, where the action is one of the following: communicating the confidence value to another device, requesting another device to perform context classification, requesting another device to collect more user feedback, providing a service.

According to a twelfth aspect, a computer program comprises instructions causing, when executed on at least one processor, at least one apparatus to: receive a location data and a first confidence value; update a database with the location data and a first confidence value; receive a second location data; obtain a second confidence value from the database corresponding to the second location data; perform an action based on the second confidence value, where the action is one of the following: communicating the confidence value to another device, requesting another device to perform context classification, requesting another device to collect more user feedback, providing a service.

According to a thirteenth aspect, an apparatus comprises processing means, memory means including computer program code, the apparatus further comprising: processing means configured to perform classification of a context using features received from at least one sensor and model parameters being defined by a training data to output a result and a likelihood of the context; displaying means configured to show the result; input means configured to obtain feedback from the user regarding the result; memory means configured to store the features, result, likelihood, and the feedback; and processing means configured to perform adaptation of the model parameters using the features, result, likelihood and the feedback to obtain adapted model parameters.

According to a fourteenth aspect, an apparatus comprises processing means, memory means including computer program code, the apparatus further comprising: processing means configured to perform a classification of a context using features received from at least one sensor and model parameters being defined by a training data to output a result and a likelihood; displaying means configured to show the result; input means configured to obtain feedback from the user regarding the result; memory means configured to store the result, likelihood and the feedback; processing means configured to perform confidence estimation to obtain a confidence value using the result, likelihood and the feedback; and processing means configured to perform an action based on the confidence value.

According to a fifteenth aspect, an apparatus comprises processing means, memory means including computer program code, the apparatus further comprising: receiving means configured to receive a location data and a first confidence value; updating means configured to update a database with the location data and a first confidence value; receiving means configured to receive a second location data; obtaining means configured to obtain a second confidence value from the database corresponding to the second location data; processing means configured to perform an action based on the second confidence value, where the action is one of the following: communicating the confidence value to another device, requesting another device to perform context classification, requesting another device to collect more user feedback, providing a service.

### DESCRIPTION OF THE DRAWINGS

In the following, various embodiments of the invention will be described in more detail with reference to the appended drawings, in which

FIG. 1 shows an embodiment of a system performing the classification;

FIG. 2 shows an embodiment of a user interface for collecting user feedback;

FIG. 3 shows an embodiment of a method for measuring a confidence value for a classification;

FIG. 4 shows an embodiment of a system for determining confidence values for a classification; and

FIG. 5 shows an embodiment of a client device.

### DETAILED DESCRIPTION OF THE EMBODIMENTS

For context recognition, various context related features can be extracted from the signals received by a plurality of different types of radio receivers of a mobile device. As a result of the extraction, the environmental context of the mobile device may be determined based on the combination of features. After this, the performance of the mobile device may be at least partially tailored in accordance with the environmental context. This means that one or more applications executed by the mobile device may take into account the environmental context and may perform or otherwise provide results that are at least partially based upon the environmental context. For example, a phone book or contacts application may present results or at least prioritize results based upon the environmental context of the mobile terminal. Additionally, an application that is intended to recommend media may make those recommendations at least partially upon the context of the mobile device. Further, the display of the mobile device may be driven in such a manner that is at least partially based upon the environmental context, such as by being driven so as to have greater brightness in an instance in which the mobile device is outside and less brightness in an instance in which the mobile device is indoors, thereby conserving battery consumption. While several examples are provided above, a mobile device may adapt its behavior in a wide variety of different manners based at least in part upon the environmental context with the foregoing examples merely intended to provide an illustration, but not a limitation, of the manners in which the performance of a mobile device may tailored to its environmental context.

Examples of the features that can be extracted from signals being received from respective receivers may include 1) a number of unique cell identities (IDs), the number of unique location area codes (LACs), the number of cell ID changes per minute, the number of location area code changes per minute and/or the standard deviation of signal strength obtained from a plurality of cellular radio receivers; 2) the maximum carrier to noise ratio, a minimum elevation angle value from the satellites, the maximum speed value, the best horizontal accuracy value of the GPS position fixes, the time to first fix (TTFF) obtained for a GPS radio receiver; 3) the number of unique media access control (MAC) addresses, the number of unique station names, the mean signal strength, the standard deviation of signal strength obtained from a WLAN radio receiver; 4) the number of Bluetooth devices with which the Bluetooth radio receiver is in communication obtained from a Bluetooth radio receiver; 5) any other features extracted from signals received by any other radio receiver, e.g. the maximum, minimum, standard deviation, median or median absolute deviation of the signals.

The features may be processed in various manners to facilitate the determination of the environmental context, for example the features can be concatenated to define a feature vector, which feature vector is then normalized e.g. by subtracting a mean vector and dividing the result with a standard deviation vector. Instead, the feature vector may be normalized by subtracting a global mean vector and dividing the result by a global co-variance matrix or variance vector. Then, the feature space may be transformed into another space of more desirable properties, such as uncorrelatedness or maximum separability of classes. In this regard, the feature space, such as the normalized feature vector, may be transformed in accordance with a linear transform, e.g., in accordance with a linear discriminant analysis. However, the normalized feature vector may be transformed in other manners including in accordance with principal component analysis, independent component analysis or non-negative matrix factorization. In one embodiment, the feature vector may be normalized by subjecting the feature vector to a plurality of different transforms performed in a sequence.

The feature vector can then be analyzed, such as the normalized, transformed feature vector, so as to determine the environmental context of the mobile device. The processor of the mobile device may determine the environmental context based upon the feature vector in various manners including the application of a classifier to the feature vector in which the classifier identifies the class associated with the feature vector with the class, in turn, being associated with a respective environmental context. The processor may utilize a variety of different classifiers including a Bayesian classifier, a neural network, a nearest neighbor classifier or a support vector machine (SVM). By determining the context model that is most representative of the feature vector, such as the normalized, transformed feature vector, the environmental context may be determined to be the same as or similar to that associated with the most representative context model.

A plurality of context models may be collected by mobile devices that are in a number of different environmental contexts, such as indoors, outdoors, in an office, at home, in natural settings or the like. For each context model, the user of the mobile device may simply select the environmental context and the mobile device may then determine the feature vector associated therewith, such as by collecting signals from the plurality of radio receivers, extracting features therefrom and then defining the corresponding feature vector. As such, a plurality of context models can be collected in an expeditious manner without significant imposition upon the users of the mobile devices. In an instance in which a plurality of context models are collected for the same or very similar environmental contexts, the plurality of context models may define a class of context models and the mean or variance of the class may be determined and then utilized as the context model representative of the respective environmental context. As such, a context model associated with a respective environmental context may include a mean vector and a co-variance matrix. During the training phase, a global mean vector and a global co-variance matrix or variance vector may be estimated based upon the mean vectors and co-variance matrices of all of the context models. These global mean vectors and global co-variance matrices or variance vectors may be stored, and utilized in order to normalize the feature vectors.

In order to determine the environmental context from the feature vector, such as a normalized transformed feature vector, the feature vector may be compared to the various context models and the context model that is most representative, such as most similar to the feature vector, is considered a match. In this regard, the environmental context associated with the context model that is most similar to the feature vector may be determined to be the environmental context in which the mobile device currently exists.

While the feature vector may be compared with the context models in various manners, one embodiment is to utilize pattern recognition. In the following, several embodiments of the invention will be described in the context of pattern recognition for comparing the feature vector with the context models and adapting the model according to user feedback.

The solution can be targeted e.g. to a use case, where an accelerometer based activity classifier, for example, is used to recognize whether the user is standing, walking, bicycling etc. To build a robust classifier that would function well for anyone using the system, a training data set of labeled accelerometer data collected from as many people as possible is needed. Training data from only one person biases the distributions towards the behavior of that one person, and the classifier might not work well for another person. The distributions trained on a large set of training data may work well on average for most people using the system, but might not work at all for some. This might be due to strange walking styles or higher than average bicycling speed or some other individual differences users might have. The present solution aims to take into account the individual differences when building a classifier.

Generally, the method functions by performing classification and prompting the user to answer whether the classification result was correct or not. The data used to obtain the classification and the user feedback is then used to adapt the class distribution.

The adaptation method presented in this application may be used to adapt models of a Bayesian maximum a posteriori classifier. Such a classifier consist of Gaussian distributions zⱼ=N(μⱼ,Σⱼ) for each class j. The mean μⱼ and variance Σⱼ for each class are obtained from a training data set. In the training data set, a set of training data feature vectors are collected for each of the classes j. The mean and variance for each class j are estimated from the feature vectors which are known to belong to the class j.

The classification of an observed input z may be done by maximizing the following equation over all classes j=1 . . . p:

$$f ( z ; {μ}_{j} , {\sum }_{j}^{ } ) = \frac{1}{\sqrt{\vert 2 π {\sum }_{j}^{ } \vert}} exp [ - \frac{{( z - {μ}_{j} )}^{T} {\sum }_{j}^{- 1} ( z - {μ}_{j} )}{2} ] \qquad [ EQUATION 1 ]$$

It is evaluated how likely it is that each of the class distributions would have produced the input z, and select the class corresponding to the maximum likelihood. The close the input z is to the class distribution, the higher likelihood there is of the class distribution having generated the input z.

### Adaptation

The adaptation of the system is done by running the classifier on various sensory inputs z, presenting the output (the most likely class) to the user, and obtaining feedback from the user on whether the classification was correct or not. The set of inputs z (feature vectors), the outputted class, and the yes/no answer from the user is stored to be used for adaptation. This is done for a while to obtain a set of data consisting of inputs z with corresponding yes or no tags describing whether the classifications were correct or not. After collecting the feedback, the adaptation may be done by minimizing the following optimization criteria for each class j separately, using the collected data:

$$f = \frac{\vert A \vert}{N ( yes )} + \frac{\vert B \vert}{N ( no )} , \qquad [ EQUATION 2 ]$$

where |S| denotes the number of items in the set S. N(yes) is the total number of “yes” answers and N(no) is the total number of “no” answers.

The sets A and B are defined as

A={Lⱼ(yes)|Lⱼ(yes)>χ₉₅} and

B={Lⱼ(no)|Lⱼ(no)<χ₉₅} [EQUATION 3]

where Lⱼ(yes) is the set of likelihood values of the observations with yes-tag, X₉₅ is the point where the cumulative chi-square distribution function with a proper degrees of freedom has a value of 0.95. Lⱼ(no) is the set of likelihood values of the observations with no-tag. The likelihood values Lⱼ are defined as:

Lⱼ=(z−μⱼ)^{T}sⱼΣⱼ⁻¹(z−μⱼ) [EQUATION 4]

The optimization is done by finding the values for mean μⱼ and a scaling factor sⱼ that minimize the function ƒ. For an unadapted model the scaling sⱼ is equal to 1.

The adaptation algorithm attempts to minimize the number of samples with yes-label that do not fit the model distribution (EQUATION 1, above) meaning that they fall outside the 95% threshold. Furthermore, the algorithm attempts to minimize the number of samples with no-label that fit the model distribution well, meaning that they fall inside the 95% threshold, sⱼ and μⱼ being the arguments:

$${arg min}_{{s}_{j} ∈ {R}^{+} , {μ}_{j} ∈ {R}^{N}} f$$

The first part of the optimization criteria (EQUATION 2) is motivated by the fact that if we draw samples from a Gaussian distribution, the likelihoods of those samples coming from the said distribution should be chi-squared distributed with q-degrees of freedom. This means that, after adaptation, the likelihoods of the samples that were tagged as correct should come from a distribution that gives likelihoods that are chi-squared distributed for those samples. In other words, during the adaptation we try to find a distribution that would give chi-squared distributed likelihoods for the correctly classified samples. Moreover, the samples that were identified as not correct by the user should not give likelihoods that are chi-squared distributed. This is reflected in the latter part of the optimization criteria.

The minimization of the optimization criteria with respect to the parameters (μⱼ and a scaling factor sⱼ) can be done, for example, by using the Matlab function “fminsearch”. The function “fminsearch” starts from an initial estimated and finds a minimum of a scalar function of several variables. This is an example of unconstrained nonlinear optimization. “fminsearch” uses the Nelder-Mead simplex search.

In summary the adaptation algorithm works as follows (for each class model separately):
1. Input: feature vectors with yes/no labels (defined by “yes” or “no” answer), unadapted model which has been trained using a large set of annotated data.
2. Parameter optimization
   a. Input: unadapted model, feature vectors with yes/no labels, function ƒ.
   b. Minimize (1) e.g. using Nelder-Mead simplex method (fminsearch). μⱼ. and sⱼ are adapted until ƒ reaches a minimum value.
   c. Output: sⱼ and μⱼ.
3. Evaluate equation 3 with adapted model parameters (μⱼ and sⱼ) and feature vectors.
4. Analyze evaluated values of equation 3 to determine whether the adapted model parameters are better than the unadapted ones
5. If the adapted model parameters are better than the unadapted models, take the adapted parameters in to use.

The first term of function ƒ can be used as criteria for stopping the whole adaptation process (no more feedback from the user required), because the theoretical distribution of the term is known when assuming the model parameters are correct. Another way is to compare predicted probabilities with the observed user feedback (this method is disclosed in more detailed in below)—if there is a clear mismatch, the adaptation process should continue.

### Alternatives

In addition to the presented function ƒ, some alternative functions could be used. For example, it is possible to maximize the average likelihood for “yes” answers and minimize the average likelihood of “no” answers. It is also possible to maximize the difference of average “yes” answer likelihood and “no” answer likelihood. Yet, it is possible to maximize the number of “yes” answers and minimize the number of “no” answers. However, as a result of testing, the function ƒ is found to work well in practice. One of the benefits is that it is numerically stable.

### Example Use Case

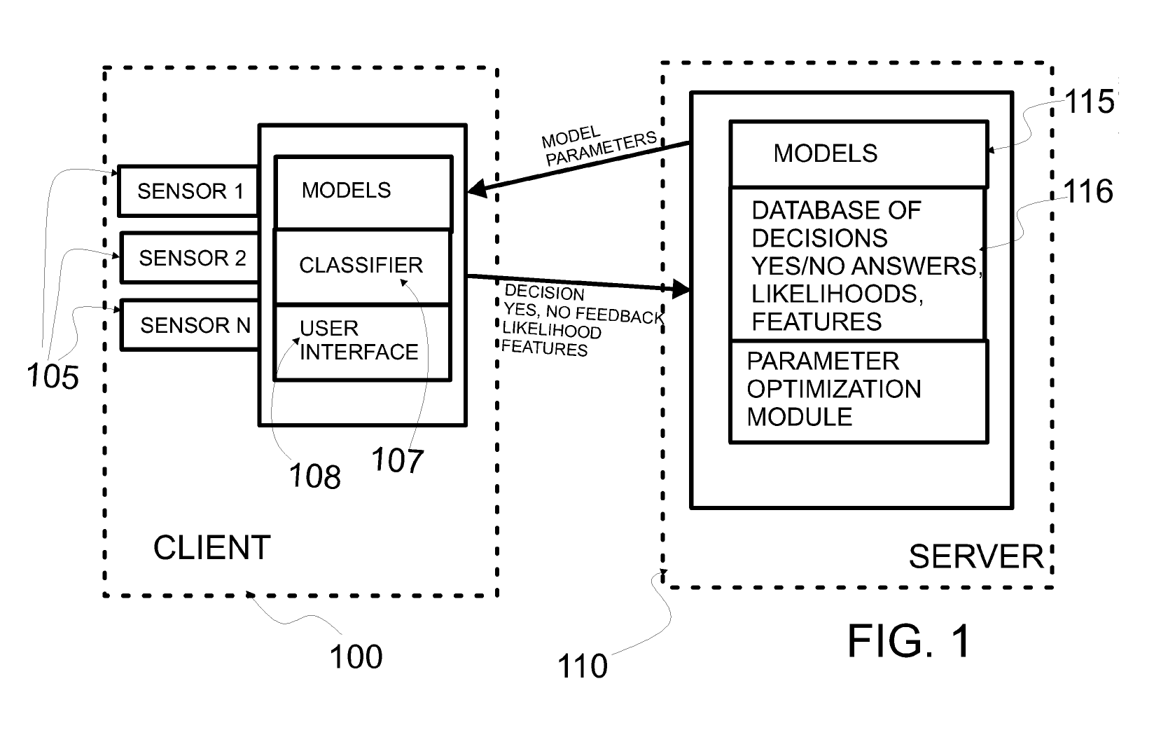

The solution described here can be used in context recognition system. A schematic diagram of the system is illustrated in FIG. 1 as an example. The system is configured to periodically recognize the users' environments and activities and based on the results, to draw environment and activity maps. The system comprises a client device (100) and a server device (110). The system may use as input such features that have been calculated from data being obtained from various sensors or radio receivers (105), for example, a Wireless Local Area Network (WLAN) radio, Global Positioning System (GPS), Bluetooth and accelerometer. The client device (mobile terminal) (100) runs a classifier (107) based on features extracted on various sensors (105) and radio receivers. The system may use a Bayesian classifier for classification. The classification result may be shown on the user interface (108) for the user, and s/he is asked to provide a “yes” or “no” answer indicating whether the classification was correct. The classification result, the obtained likelihood value, and the yes/no answer is sent to the server side (110). The server side (110) may store the original context model parameters (115), and all the obtained adaptation data (classification results, likelihoods, yes/no answers) (116). The server side (110) performs the adaptation procedure by minimizing the function ƒ, and communicates the updated model parameters to the client device.

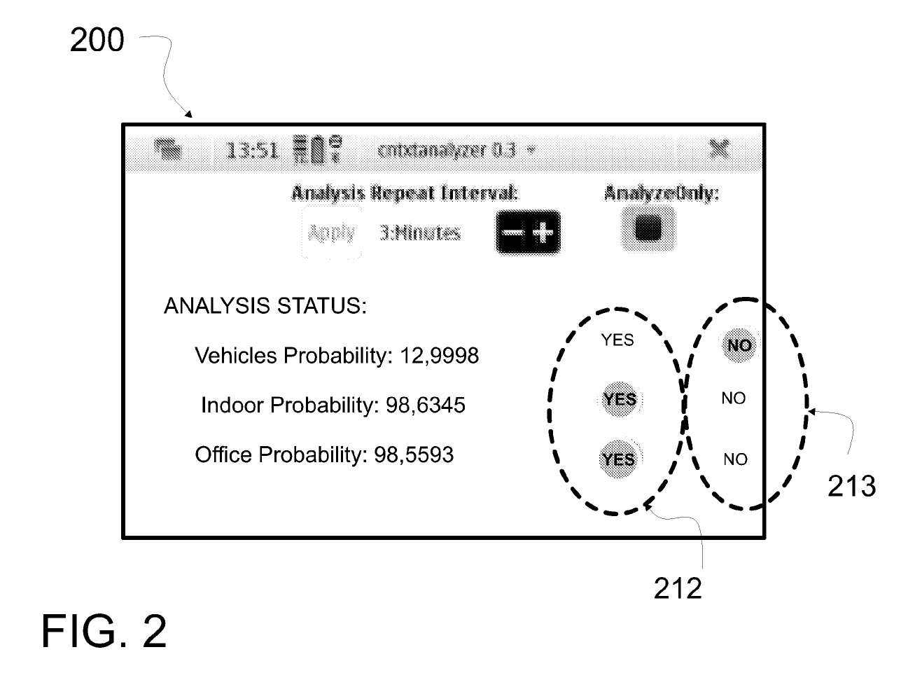

The present solution has been tested with test persons carrying mobile devices. FIG. 2 illustrates an example of a user interface (200) that is configured to collect user feedback on classifier performance. After the system has determined the probabilities on the context of the user, the probabilities are shown on the user interface (200). It can be seen that the system has determined that the probability of the user being in vehicles is 12.9998 and the probability of the user being indoors is 98.6345 and at the office is 98.5593. Probabilities are expressed as percentages in this case. Furthermore in this example implementation, three different context classifiers were employed, one classifying between contexts indoor and outdoor, another classifying the user activity and in this case the most likely class being vehicles, and the third classifier classified the environment context and in this case the most likely class was office. The test persons are then asked—via the user interface shown in FIG. 2—to answer {yes, no} to the recognition result in order to confirm the classifier results. The available answer buttons for “yes” are shown with reference 212, and the available answer buttons for “no” are shown with reference 213. The gray circles around two “yes” answers and one “no” answer indicate the selections of the user: “I'm not in vehicles, but indoors at the office”. This kind of binary feedback does not require a big effort, but the results show that the information is very valuable in both adaptation and evaluation of the classifier performance. The skilled person appreciates that any visual element in FIG. 2 can be replaced with any other visual element, for example gray circles around “yes” and “no” answers can be replaced with green and red circles respectively, or with any other element having different color or shape. In addition, the user interface can include any other input means for the user to answer “yes”/“no” instead of the buttons 212, 213. For example, in some cases the user may type answers “yes”/“no” to corresponding fields or the user interface may operate at least partly by voice recognition whereby the user may only speak out the words “yes”/“no”.

Thanks to the present solution, the user feedback is less time consuming for users than in traditional adaptation method. This is because, the user has to answer only yes or no depending on whether the classification is correct or not. Traditional methods require the user to provide class labels with the adaptation data. As a difference to the solutions of related technology, a covariance matrix is adapted in the present solution. This is a great achievement compared to prior art solutions. Also, the present solution comprises a stopping criterion for adaptation.

In above, it was said that the first term of function ƒ can be used as stopping criterion. Another way is to compare predicted probabilities with the observed user feedback. This method is disclosed next.

### User Feedback Based Confidence Measure for Classifiers

This part of the solution relates to calculating a confidence value for a classification result from a Bayesian classifier.

A Bayesian maximum a posteriori classifier consists of Gaussian distributions zⱼ=N(μⱼ,Σⱼ) for each class j. The mean μⱼ and variance Σⱼ for each class are obtained from a training data set. The classification of an observed input z is done by maximizing the following equation over all classes j=1 . . . p:

$$f ( z ; {μ}_{j} , {\sum }_{j}^{ } ) = \frac{1}{\sqrt{\vert 2 π {\sum }_{j}^{ } \vert}} exp [ - \frac{{( z - {μ}_{j} )}^{T} {\sum }_{j}^{- 1} ( z - {μ}_{j} )}{2} ] \qquad [ EQUATION 5 ]$$

The classification output is the class j, which maximizes the above equation. Notice that if the input z does not belong to any of the p classes, the classifier still finds the class which maximizes the equation. Thus, for real life applications it would be beneficial to have some sort of measure of confidence that the recognized class is also the correct one in addition to being the most likely one. Also, in real life applications, the classifier is bound to make mistakes. Noticing when these mistakes happen would be very beneficial as well. These problems are overcome with this part of the solution. The aim of the solution is to calculate a confidence value that tells how confident one can be that the classification result is correct. The confidence measure can be used in a power saving scheme for context recognition in mobile devices, or as a stopping criterion for adaptation.

### the Confidence Measure

A confidence value can be calculated to determine how confident the classification result is. The calculation can be performed by using the following equation:

$${P}_{yes \vert L} = \frac{{p}_{L \vert yes} {P}_{yes}}{{p}_{L}} \qquad [ EQUATION 6 ]$$

where P_{yes|L} is the probability being looked for, probability of user answering “yes” given the likelihood value of the class that had the highest likelihood. p_{L|yes} is the (empirical) conditional density of the yes-likelihood. P_{yes} is the prior probability of successful detection. p_{L} is the weighted combination of “yes” and “no” likelihoods. Thus, to calculate the confidence value, terms P_{yes}, p_{L|yes} and p_{L} need to be calculated.

To calculate the terms, the first step is to collect feedback by running a classifier normally and receiving user feedback on whether the classification results where correct or not (“yes”/“no” answers) (as described above). The likelihoods of the recognized classes and the user feedback may be stored. After enough data has been collected, the data can be used to calculate the terms P_{yes}, p_{L|yes} and p_{L}. These are calculated as shown below:
1. The value for p_{L|yes} is obtained by calculating a probability density function of the likelihoods of when the classifier successfully recognized the correct class. This can be done, for example, using Matlab function “ksdensity” which performs kernel estimation of the likelihood probability density function, or calculating a histogram of the likelihood value corresponding to the “yes” answers. p_{L|yes} is then the value of the probability density function at the likelihood of the recognized class.
2. The value for P_{yes}=N_{yes}/(N_{yes}+Nₙₒ), where N_{yes} is the number of “yes” answers from the user and Nₙₒ is the number of “no” answers from the user
3. p_{L}=P_{yes}p_{L|yes}+PₙₒP_{L|no}, where P_{yes} is the prior probability of successful detection, and p_{L|yes} is the (empirical) conditional density of the “yes”-likelihood, and where Pₙₒ and p_{L|no} are calculated in the same way, but based on the “no”-answers.

### Example Use Case

In this example, the solution is applied to power saving scheme for context recognition. Therefore, the idea is to estimate the context detection confidence obtained using various sensors and features, and selectively enable only the sensors which provide maximal increase in context sensing confidence within the given energy budget. As an example there is a user activity recognition system which tries to recognize whether the user is walking, standing, bicycling, driving a car, etc. The system works on a set of features obtained from various sensors on a mobile device. These sensors may include an accelerometer, microphone, Bluetooth radio, WLAN radio and GPS receiver among others. To obtain the best recognition accuracy from the system, data from all of the sensors should be used. However, in some cases the power consumed by the sensors is too much (e.g. phone battery too low). It would be beneficial to be able to switch some of the sensors off such that the recognition accuracy is not affected too much but such that power saving is achieved. For this purpose it is possible to use the confidence measure presented here.

Other example relating to the uses of the confidence value include, for example, changing a device profile and/or launching an application. Term “device profile” relates to a set of settings of the device, such as the ring tone and alert tones, related to a certain environment or context. The main principle is that if the confidence value is high enough, for example, above a certain threshold, an action can be performed. An action can be, for example, changing the device profile. For example, if the device context is car with a confidence of 0.99, which may correspond to a high confidence, then the device can automatically switch to a car profile and bring up the navigation application and change the user interface layout to make the device easy to operate in a car environment. Correspondingly, if the confidence value of the context classifier is low, determined for example by comparing against a threshold and noticing that it is less than the threshold, the device may instead determine not to change the profile. That is, if the confidence of the classification is not large enough it is better not to make the action, such as changing device profile or launch an application so that we do not distract the user in wrong situations.

In one embodiment, there are different confidence values for different actions of the device. For example, different profiles may have different predefined confidence values before they are automatically enabled. For example, the car profile may have a confidence threshold of 0.9 before it is enabled, whereas the street profile may have a confidence threshold of 0.8 and the meeting profile a confidence threshold of 0.9. The threshold may be determined based on how critical it is if the automatic profile change is done incorrectly. For example, the street profile might have a lower confidence threshold than the meeting profile since if the street profile is enabled as a result of incorrect classification, the user will not miss any calls if the street profile ring tone is louder than the normal profile ring tone. If a meeting profile is enabled as a result of incorrect context classification, the user might miss a call since a meeting profile may typically have a quiet or silent ring tone. Correspondingly, different applications or other device actions might have different confidence levels before they are automatically started. For example, if the action to be triggered based on context value just rearranges some icons on the user interface, the confidence threshold may be relatively low since it is not critical if the context classification goes incorrectly. However, if the action opens an application which fills the full screen, such as the Web browser, the confidence threshold may be higher to prevent the system from unnecessarily often from automatically starting this application.

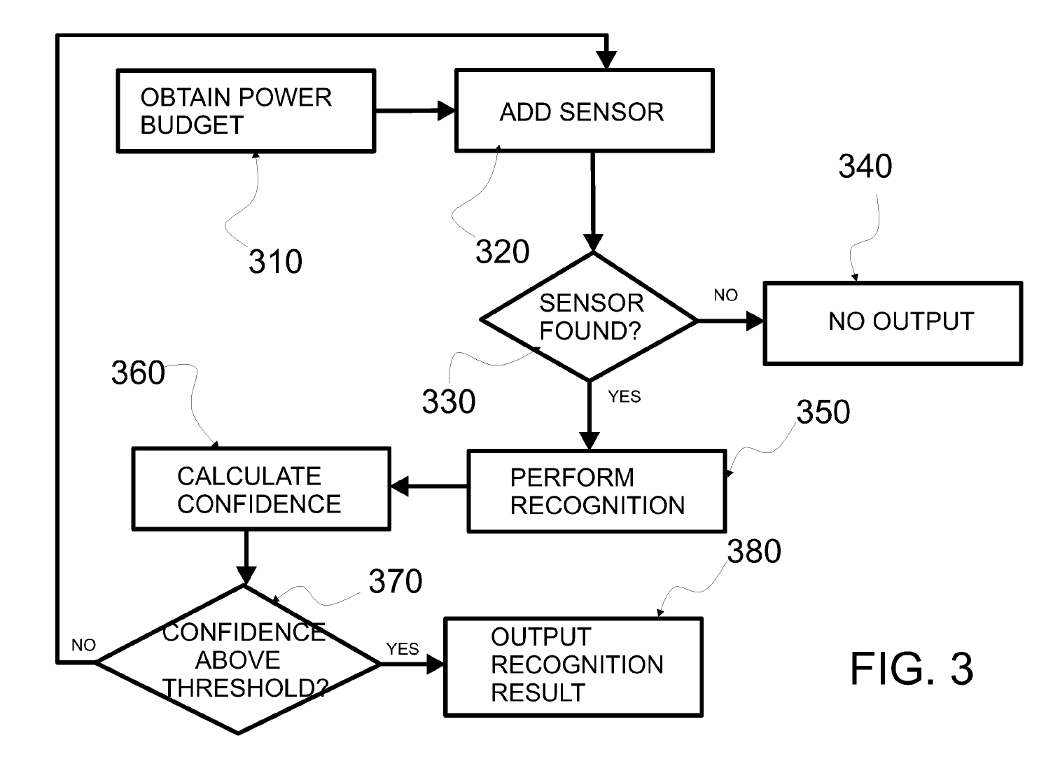

The procedure is shown in FIG. 3 as an example. In the method, a power budget is obtained (310). The input to the method is the amount of power allocated to the activity recognizer. Then a sensor is added (320). The sensor should be such that it adds the least amount of power consumption to the power consumption of the set of sensors already used for recognition. Also, adding the sensor should not cause the power budget to be breached. As a following step it is determined whether a suitable sensor was found (330). If there is no sensor such that after adding it, the power budget holds, the procedure should be stopped and recognition result is not output (340). Otherwise the process is continued. The recognition is then performed by using the selected sensors (350). The confidence of the recognition result can then be calculated (360). If confidence is above a threshold output recognition result (370), the recognition result is outputted (380), otherwise the process goes back to sensor adding step (320). The value of the threshold may vary according to the situation. For some applications, the requirements for confidence are more strict (high threshold), and for some applications the confidence requirements are lower. The sensor adding step (320) can also be replaced with other means of adding a new sensor to the sensor pool. For example, it is possible to choose a sensor that requires the most power, but still fits the budget.

### Example Use Case 2:

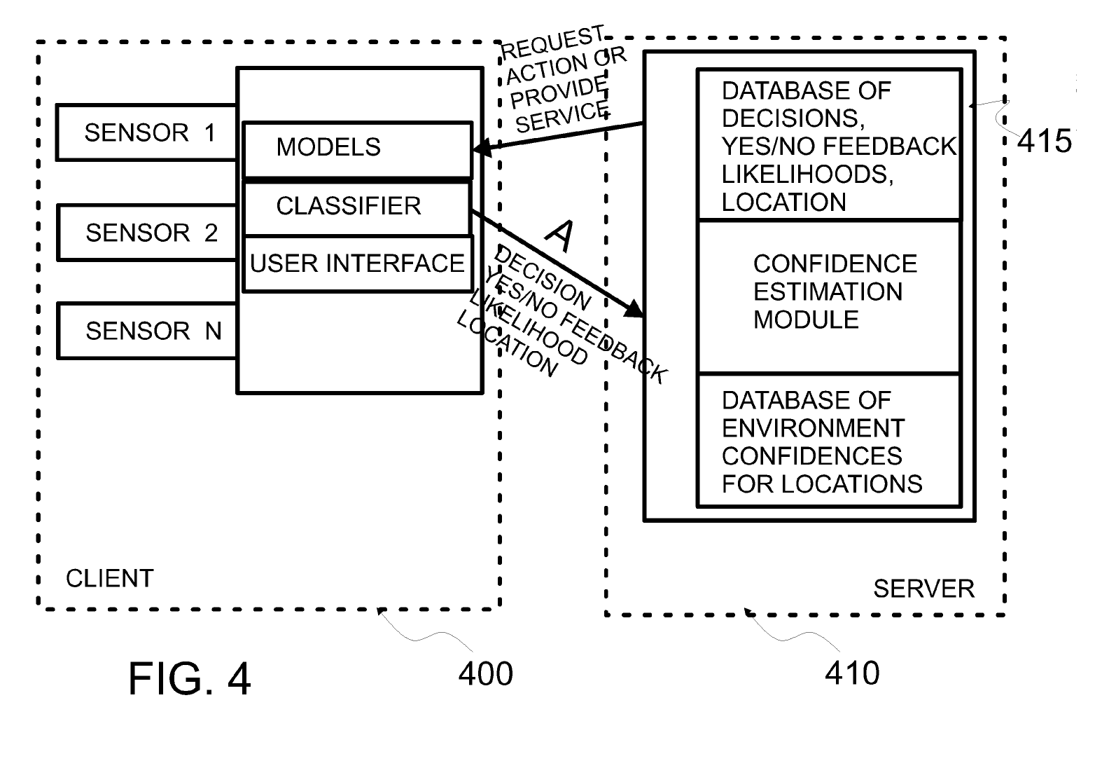

FIG. 4 illustrates another use case. The figure shows a client (400)-server (410) system, where the client device (400) is configured to perform context recognition and collect user feedback for the context classification. The client device (400) is configured to obtain the location data, such as GPS coordinates or a cellular network identifier, and to communicate (A) the location data along with the classification result, likelihood value and user feedback to the server device (410). The server device (410) comprises a database (415) which stores the classification results, likelihood values and confidences linked to different locations.

When receiving a new location data from the client device (400) (i.e. a mobile terminal), the server device is configured to search a confidence value linked to the location for each class from the database. This gives an indication of the probability of correct classification at this location. If it is high, the context classification can be reacted to e.g., by providing services, such as recommendations or advertisements to the user of the client device from the location data was received. If the confidence is low, understanding of the location needs to be increased, either by requesting the client device (400) to perform further context classification or by requesting client device (400) to collect more feedback from the user.

The present solution makes it possible to calculate user-specific confidence values with yes/no-feedback, even though the classifier is the same for all users. Also, there is no need to calculate probability density function from features. Calculating a likelihood probability density function requires less data as the dimensionality is lower. Likelihood probability density function is one-dimensional, and non-parametric probability density function estimation is thus straightforward. Because the solution operates on likelihoods, the exact same algorithm will work on any classifier outputting likelihoods with the classification result. There is no need to know anything about the actual features used in the system, which differentiates the solution from prior art solutions.

The various embodiments of the invention can be implemented with the help of computer program code that resides in a memory and causes the relevant apparatuses to carry out various embodiments. For example, a client device may comprise circuitry and electronics for handling, receiving and transmitting data, computer program code in a memory, and a processor that, when running the computer program code, causes the client device to carry out the features of an embodiment. Yet further, a server device may comprise circuitry and electronics for handling, receiving and transmitting data, computer program code in a memory, and a processor that, when running the computer program code, causes the network device to carry out the features of an embodiment.

In at least some embodiments, the system includes the server device and a plurality of client devices. The server device may be in communication with one or more client devices over the network. The network may comprise a wireless network (e.g., a cellular network, wireless local area network, wireless personal area network, wireless metropolitan area network, and/or the like), a wireline network, or some combination thereof, and in some embodiments comprises at least a portion of the internet. The server device may be embodied as one or more servers, one or more desktop computers, one or more laptop computers, one or more mobile computers, one or more network nodes, multiple computing devices in communication with each other, any combination thereof, and/or the like. In this regard, the server device may comprise any computing device or plurality of computing devices configured to provide context-based services to one or more client devices over the network. The client device may be embodied as any computing device, such as, for example, a desktop computer, laptop computer, mobile terminal, mobile computer, mobile phone, mobile communication device, game device, digital camera/camcorder, audio/video player, television device, radio receiver, digital video recorder, positioning device, wrist watch, portable digital assistant (PDA), any combination thereof, and/or the like. In this regard, the client device may be embodied as any computing device configured to ascertain a position of the client device and access context-based services provided by the server device over the network.

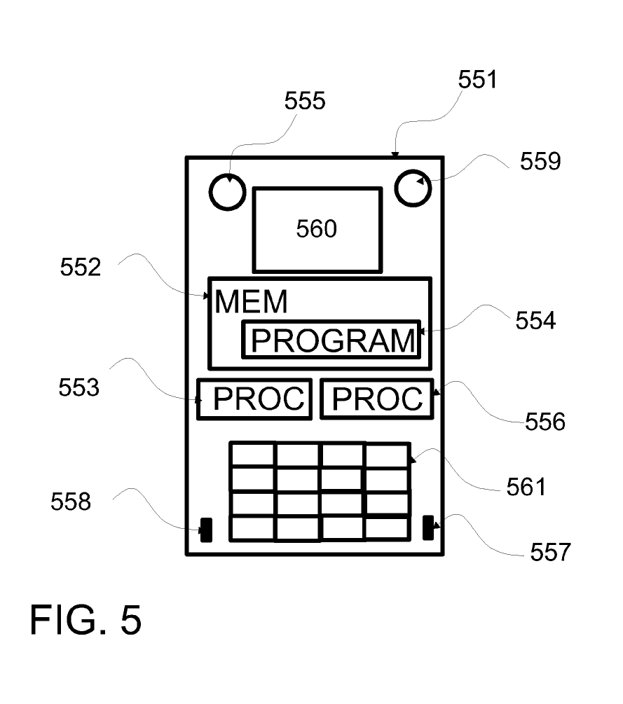

FIG. 5 shows an example of an apparatus 551, i.e. client device, for carrying out the context recognition method. As shown in FIG. 5, a mobile terminal being an example of the client device contains memory 552, at least one processor 553 and 556, and computer program code 554 residing in the memory 552. The apparatus may also have one or more cameras 555 and 559 for capturing image data, for example stereo video. The apparatus may also contain one, two or more microphones 557 and 558 for capturing sound. The apparatus may also comprise a display 560. The apparatus 551 may also comprise an interface means (e.g., a user Interface) which may allow a user to interact with the device. The user interface means may be implemented using a display 560, a keypad 561, voice control, gesture recognition or other structures. The apparatus may also be connected to another device e.g. by means of a communication block (not shown in FIG. 5) able to receive and/or transmit information. For example, the apparatus may comprise a short-range radio frequency (RF) transceiver and/or interrogator so data may be shared with and/or obtained from electronic devices in accordance with RF techniques. The apparatus may comprise other short-range transceivers, such as, for example, an infrared (IR) transceiver, a Bluetooth™ (BT) transceiver operating using Bluetooth™ brand wireless technology developed by the Bluetooth™ Special Interest Group, a wireless universal serial bus (USB) transceiver and/or the like. The Bluetooth™ transceiver may be capable of operating according to ultra-low power Bluetooth™ technology (for example, Wibree™) radio standards. In this regard, the apparatus and, in particular, the short-range transceiver may be capable of transmitting data to and/or receiving data from electronic devices within a proximity of the apparatus, such as within 10 meters, for example. Although not shown, the apparatus may be capable of transmitting and/or receiving data from electronic devices according to various wireless networking techniques, including Wireless Fidelity (Wi-Fi), WLAN techniques such as IEEE 802.11 techniques, IEEE 802.15 techniques, IEEE 802.16 techniques, and/or the like. Although not shown, the apparatus may comprise a battery for powering various circuits related to the apparatus, for example, a circuit to provide mechanical vibration as a detectable output. In addition, the apparatus may comprise circuitry and electronics for handling, receiving and transmitting data, computer program code in a memory, and a processor that, when running the computer program code, causes the apparatus to carry out the features of an embodiment. Further, the apparatus may comprise various sensors as shown in FIGS. 1 and 4.

The one or more processors 553, 556 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. These signals sent and received by the processor 553, 556 may include signaling information in accordance with an air interface standard of an applicable cellular system, and/or any number of different wireline or wireless networking techniques, comprising but not limited to Wireless-Fidelity (Wi-Fi), wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the apparatus may be capable of operating with one or more air interface standards, communication protocols, modulation types, access types, and/or the like. More particularly, the apparatus may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (for example, session initiation protocol (SIP)), and/or the like. For example, the apparatus may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the apparatus may be capable of operating in accordance with 2.5G wireless communication protocols General Packet Radio Service (GPRS), Enhanced Data GSM Environment (EDGE), and/or the like. Further, for example, the apparatus may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus may be additionally capable of operating in accordance with 3.9G wireless communication protocols such as Long Term Evolution (LTE) or Evolved Universal Terrestrial Radio Access Network (E-UTRAN) and/or the like. Additionally, for example, the apparatus may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), apparatuses may also benefit from embodiments of this invention, as should dual or higher mode phones (for example, digital/analog or TDMA/CDMA/analog phones). Additionally, the apparatus 551 may be capable of operating according to Wireless Fidelity (Wi-Fi) or Worldwide Interoperability for Microwave Access (WiMAX) protocols.

It is understood that the processor 553, 556 may comprise circuitry for implementing audio/video and logic functions of the apparatus 551. For example, the processor 553, 556 may comprise a digital signal processor device, a microprocessor device, an analog-to-digital converter, a digital-to-analog converter, and/or the like. Control and signal processing functions of the apparatus may be allocated between these devices according to their respective capabilities. The processor may additionally comprise an internal voice coder, an internal data modem, and/or the like. Further, the processor may comprise functionality to operate one or more software programs, which may be stored in memory 552. For example, the processor 553, 556 may be capable of operating a connectivity program, such as a web browser. The connectivity program may allow the apparatus 551 to transmit and receive web content, such as location-based content, according to a protocol, such as Wireless Application Protocol (WAP), hypertext transfer protocol (HTTP), and/or the like. The apparatus 551 may be capable of using a Transmission Control Protocol/Internet Protocol (TCP/IP) to transmit and receive web content across the internet or other networks.

In addition, the apparatus 551 in some embodiments includes positioning circuitry (not shown). The positioning circuitry may include, for example, a GPS sensor, an assisted global positioning system (Assisted-GPS) sensor, a Bluetooth (BT)-GPS mouse, other GPS or positioning receivers, or the like. However, in one exemplary embodiment, the positioning circuitry may include an accelerometer, pedometer, or other inertial sensor. In this regard, the positioning circuitry may be capable of determining a location of the apparatus 551, such as, for example, longitudinal and latitudinal directions of the apparatus 551, or a position relative to a reference point such as a destination or start point. Further, the positioning circuitry may determine the location of the apparatus 551 based upon signal triangulation or other mechanisms. As another example, the positioning circuitry may be capable of determining a rate of motion, degree of motion, angle of motion, and/or type of motion of the apparatus 551, such as may be used to derive activity context information. Information from the positioning sensor may then be communicated to a memory of the apparatus 551 or to another memory device to be stored as a position history or location

In an embodiment, the processing means are configured to perform classification on a context using features received from at least one sensor and model parameters being defined by a training data to output a result and a likelihood of the context; displaying means are configured to show the result to a user; input means are configured to obtain feedback from the user regarding the result; memory means are configured to store the features, result, likelihood, and the feedback; and processing means are further configured to perform adaptation of the model parameters using the features, result, likelihood and the feedback to obtain adapted model parameters.

In another embodiment, the processing means are configured to perform a classification on a context using features received from at least one sensor and model parameters being defined by a training data to output a result and a likelihood; displaying means are configured to show the result to a user; input means are configured to obtain feedback from the user regarding the result; memory means are configured to store the result, likelihood and the feedback; processing means are configured to perform confidence estimation to obtain a confidence value using the result, likelihood and the feedback; and processing means are further configured to perform an action based on the confidence value.

In an embodiment, the server device comprises processing means, memory means including computer program code, the apparatus further comprising: receiving means configured to receive a location data and a first confidence value; updating means configured to update a database with the location data and a first confidence value; receiving means configured to receive a second location data; obtaining means configured to obtain a second confidence value from the database corresponding to the second location data; processing means configured to perform an action based on the second confidence value, where the action is one of the following: communicating the confidence value to another device, requesting another device to perform context classification, requesting another device to collect more user feedback, providing a service.

The present solution for context recognition represents a substantial advancement in this field of technology as to its fastness and accurateness. The solution employs an adaptation method of class distributions in e.g. Bayesian classifier. The solution also provides a stopping criterion for stopping the adaptation procedure.

It is obvious that the present invention is not limited solely to the above-presented embodiments, but it can be modified within the scope of the appended claims.

1-59. (canceled)

60. A method, comprising:
performing classification of a context using features received from at least one sensor and model parameters being defined by a training data to output a result and a likelihood of the context;
showing the result;
obtaining feedback from the user regarding the result;
storing the features, result, likelihood, and the feedback; and
performing adaptation of the model parameters using the features, result, likelihood and the feedback to obtain adapted model parameters.

61. The method according to claim 60, further comprising evaluating a function ƒ, where the evaluation of the function ƒ comprises evaluating the likelihood values corresponding to yes and no answers against a threshold.

62. The method according to claim 61, where the function ƒ is in the form of
$$f = \frac{\vert A \vert}{N ( yes )} + \frac{\vert B \vert}{N ( no )} ,$$
and where A={Lⱼ(yes)|Lⱼ(yes)>χ₉₅} and
B={Lⱼ(no)|Lⱼ(no)<χ₉₅} and where

|A| denotes the number of items in the set A;
j is an index of the current class;
Lⱼ(no) is the set of likelihood values corresponding to observations with “no”-tag;
N(no) is the total number of “no” answers;
Lⱼ(yes) is the set of likelihood values corresponding to observations with “yes”-tag;
N(yes) is the total number of “yes” answers;
the likelihood values Lⱼ are defined as: Lⱼ=(z−μⱼ)^{T}sⱼΣⱼ⁻¹(z−μⱼ)
and adapted class parameters are obtained from
$${arg min}_{{s}_{j} ∈ {R}^{+} , {μ}_{j} ∈ {R}^{N}} f$$

63. The method according to claim 60, further comprising:
communicating the features, result, likelihood and the feedback to another device; and
receiving adapted model parameters from the other device.

64. The method according to claim 61, further comprising:
minimizing the function ƒ; and
stopping the adaptation when the function ƒ reaches the minimum.

65. The method according to the claim 60, further comprising:
performing confidence estimation to obtain a confidence value using the result, likelihood and the feedback; and
stopping the adaptation if the confidence value substantially matches the user feedback.

66. An apparatus comprising a processor, memory including computer program code, the memory and the computer program code configured to, with the processor, cause the apparatus to perform at least the following:
perform classification of a context using features received from at least one sensor and model parameters being defined by a training data to output a result and a likelihood of the context;
show the result;
obtaining feedback from the user regarding the result;
store the features, result, likelihood, and the feedback; and
perform adaptation of the model parameters using the features, result, likelihood and the feedback to obtain adapted model parameters.

67. The apparatus according to claim 66, further comprising computer program code configured to, with the processor, cause the apparatus to perform at least the following:
evaluate the likelihood values corresponding to yes and no answers against a threshold for the evaluation of a function ƒ.

68. The apparatus according to claim 67, where the function ƒ is in the form of
$$f = \frac{\vert A \vert}{N ( yes )} + \frac{\vert B \vert}{N ( no )} ,$$
and where A={Lⱼ(yes)|Lⱼ(yes)>χ₉₅} and
B={Lⱼ(no)|Lⱼ(no)<χ₉₅} and where

|A| denotes the number of items in the set A;
j is an index of the current class;
Lⱼ(no) is the set of likelihood values corresponding to observations with “no”-tag;
N(no) is the total number of “no” answers;
Lⱼ(yes) is the set of likelihood values corresponding to observations with “yes”-tag;
N(yes) is the total number of “yes” answers;
the likelihood values Lⱼ are defined as: Lⱼ=(z−μⱼ)^{T}sⱼΣⱼ⁻¹(z−μⱼ)
and adapted class parameters are obtained from
$${arg min}_{{s}_{j} ∈ {R}^{+} , {μ}_{j} ∈ {R}^{N}} f$$

69. The apparatus according to the claim 66, further comprising computer program code configured to, with the processor, cause the apparatus to perform at least the following:
communicate the features, result, likelihood and the feedback to another device; and
receive adapted model parameters from the other device.

70. The apparatus according to the claim 67, further comprising computer program code configured to, with the processor, cause the apparatus to perform at least the following:
minimize the function ƒ; and
stop the adaptation when the function ƒ reaches the minimum.

71. The apparatus according to the claim 66, further comprising computer program code configured to, with the processor, cause the apparatus to perform at least the following:
perform confidence estimation to obtain a confidence value using the result, likelihood and the feedback; and
stop the adaptation if the confidence value substantially matches the user feedback.

72. An apparatus comprising a processor, memory including computer program code, the memory and the computer program code configured to, with the processor, cause the apparatus to perform at least the following:
perform a classification of a context using features received from at least one sensor and model parameters being defined by a training data to output a result and a likelihood;
show the result;
obtain feedback from the user regarding the result;
storing the result, likelihood and the feedback;
perform confidence estimation to obtain a confidence value using the result, likelihood and the feedback; and
perform an action based on the confidence value.

73. A computer program embodied on a non-transitory computer readable medium, the computer program comprising instructions causing, when executed on at least one processor, at least one apparatus to:
perform classification of a context using features received from at least one sensor and model parameters being defined by a training data to output a result and a likelihood of the context;
show the result;
obtain feedback from the user regarding the result;
store the features, result, likelihood, and the feedback; and
perform adaptation of the model parameters using the features, result, likelihood and the feedback to obtain adapted model parameters.

74. The computer program according to claim 73, wherein the apparatus is further caused to: evaluate a function ƒ, where the evaluation of the function ƒ comprises evaluating the likelihood values corresponding to yes and no answers against a threshold.

75. The computer program according to claim 74, where the function ƒ is in the form of
$$f = \frac{\vert A \vert}{N ( yes )} + \frac{\vert B \vert}{N ( no )} ,$$
and where A={Lⱼ(yes)|Lⱼ(yes)>χ₉₅} and
B={Lⱼ(no)|Lⱼ(no)<χ₉₅} and where

|A| denotes the number of items in the set A;
j is an index of the current class;
Lⱼ(no) is the set of likelihood values corresponding to observations with “no”-tag;
N(no) is the total number of “no” answers;
Lⱼ(yes) is the set of likelihood values corresponding to observations with “yes”-tag;
N(yes) is the total number of “yes” answers;
the likelihood values Lⱼ are defined as: Lⱼ=(z−μⱼ)^{T}sⱼΣⱼ⁻¹(z−μⱼ)
and adapted class parameters are obtained from
$${arg min}_{{s}_{j} ∈ {R}^{+} , {μ}_{j} ∈ {R}^{N}} f$$

76. The computer program according to claim 73, wherein the apparatus is further caused to:
communicate the features, result, likelihood and the feedback to another device; and
receive adapted model parameters from the other device.

77. The computer program according to claim 74, wherein the apparatus is further caused to:
minimize the function ƒ; and
stop the adaptation when the function ƒ reaches the minimum.

78. The computer program according to the claim 73, wherein the apparatus is further caused to:
perform confidence estimation to obtain a confidence value using the result, likelihood and the feedback; and
stop the adaptation if the confidence value substantially matches the user feedback.

79. A computer program embodied on a non-transitory computer readable medium, the computer program comprising instructions causing, when executed on at least one processor, at least one apparatus to:
perform a classification of a context using features received from at least one sensor and model parameters being defined by a training data to output a result and a likelihood;
show the result;
obtain feedback from the user regarding the result;
storing the result, likelihood and the feedback;
perform confidence estimation to obtain a confidence value using the result, likelihood and the feedback; and
perform an action based on the confidence value.
